(19) United States
(12) Patent Application Publication
(10) Pub. No.: US 2021/0157289 A1
(43) Pub. Date: May 27, 2021

(54) MULTIFUNCTIONAL ENERGY STORAGE SYSTEM AND OPERATING METHOD THEREOF

(71) Applicant: Korea Institute of Energy Research, Daejeon (KR)

(72) Inventors: Jong Bok BAEK, Daejeon (KR); Kuk Yeol BAE, Daejeon (KR); Mo Se KANG, Daejeon (KR); Sea Seung OH, Seoul (KR); Su Yong CHAE, Daejeon (KR); Seon Ri HONG, Daejeon (KR); Hak Geun JEONG, Daejeon (KR)

(73) Assignee: Korea Institute of Energy Research, Daejeon (KR)

(21) Appl. No.: 16/899,277

(22) Filed: Jun. 11, 2020

(30) Foreign Application Priority Data
Nov. 21, 2019 (KR) 10-2019-0150682

(51) Int. Cl. G05B 19/042; H02J 13/00

(52) U.S. Cl. CPC G05B 19/042; G05B 2219/2639; H02J 13/00034

(57) ABSTRACT

The present disclosure relates to a multifunctional energy storage system in which one energy storage system is capable of performing a plurality of functions and an operating method thereof. According to an aspect of the present disclosure, there is provided a multifunctional energy storage system including: a battery; a power converter to transfer power between a system and the battery; a multi-function controller to select the activation functions, to generate an integrated objective function, a weight, and a constraint condition corresponding to the activation functions, and to generate a control value for controlling each function included in the activation functions on the basis of the integrated objective function, the weight, and the constraint condition; and an individual function controller to receive the control value for each of the activation functions from the multi-function controller and to control the power converter so that each function is performed on the basis of the received control value.

### CROSS REFERENCE TO RELATED APPLICATION

This application claims priority from Korean Patent Application No. 10-2019-0150682, filed on Nov. 21, 2019, which is hereby incorporated by reference for all purposes as if fully set forth herein.

### BACKGROUND OF THE INVENTION

### 1. Field of the Invention

The present disclosure relates to a multifunctional energy storage system in which one energy storage system is capable of performing a plurality of functions and an operating method thereof.

### 2. Description of the Prior Art

Recently, the use of energy storage systems (ESS) has been increasing. An energy storage system may be installed in a generating station, a transmission and distribution station, a distributed power source, or a consumer house and may be used for various purposes. For example, an energy storage system installed at a generating station or a distributed power source may generally perform a function of maximum power level control, ramp rate control, or power smoothing; an energy storage system installed at a transmission and distribution station may generally perform a function of frequency regulation, voltage regulation, or island mode operation control; and an energy storage system installed at a customer house may generally perform a function of peak shaving or demand response control.

However, although having various advantages, energy storage systems are not yet satisfactory in economic efficiency due to high costs for initial installation and maintenance. Therefore, efforts are needed to increase the profitability of an energy storage system.

Generally, a current energy storage system is designed according to an intended function to be performed, which is specified at the time of installation, and is allowed to perform only the function. In this case, an individual design is required according to the purpose of installing an energy storage system, which increases costs in design and inspection. Further, an energy storage system capable of performing various functions is used for a single purpose, thus reducing the profitability thereof.

It is necessary to enable an energy storage system to be used for various functions to reduce costs in design and inspection and to increase the utilization thereof, thus maximizing the profitability thereof.

### SUMMARY OF THE INVENTION

An embodiment of the present disclosure is to provide an energy storage system capable of selectively performing various functions at the same time as necessary, and an operating method thereof.

An embodiment of the present disclosure is to provide an energy storage system capable of automatically recombining and activating functions capable of optimizing an objective function among various functions depending on the situation, and an operating method thereof.

An embodiment of the present disclosure is to provide an energy storage system capable of operating to reduce an error predicted when performing a function on the basis of previous data, thus increasing the reliability of the system, and an operating method thereof.

According to an aspect of the present disclosure, there is provided a multifunctional energy storage system capable of selecting and simultaneously performing at least two activation functions among a plurality of functions, the multifunctional energy storage system including: a battery; a power converter to transfer power between a system and the battery; a multi-function controller to select the activation functions, to generate an integrated objective function, a weight, and a constraint condition corresponding to the activation functions, and to generate a control value for controlling each function included in the activation functions on the basis of the integrated objective function, the weight, and the constraint condition; and an individual function controller to receive the control value for each of the activation functions from the multi-function controller and to control the power converter so that each function is performed on the basis of the received control value.

In the multifunctional energy storage system, the plurality of functions may include at least two among maximum power level control, ramp rate control, power smoothing, frequency regulation, voltage regulation, island mode operation control, peak shaving, demand response control, active power control, and reactive power control.

In the multifunctional energy storage system, the multi-function controller may select, as the activation functions, at least some of functions operable together with a function selected by a user.

In the multifunctional energy storage system, the multi-function controller may include: a weight generation unit to generate the weight for each of the activation functions; an integrated objective function generation unit to generate the integrated objective function for all the activation functions by reflecting the weight; a constraint condition generation unit to generate the constraint condition for the activation functions; and an optimization controller to generate the control value for each of the activation functions on the basis of the integrated objective function and the constraint condition.

In the multifunctional energy storage system, the multi-function controller may include a multi-function recombination unit to perform multi-function recombination of collecting future prediction information, generating a temporary function combination, providing the temporary function combination to the integrated objective function generation unit, the weight generation unit, and the constraint condition generation unit, receiving an optimization result of the temporary function combination from the optimization controller, selecting an optimal function combination on the basis of the optimization result of the temporary function combination, and providing the optimal function combination to a simultaneous control activation unit.

In the multifunctional energy storage system, the simultaneous control activation unit may change the activation functions on the basis of the optimal function combination provided from the multi-function recombination unit.

In the multifunctional energy storage system, the multi-function recombination unit may perform the multi-function recombination when an inflection point occurs in an optimization result of the integrated objective function for the activation functions.

In the multifunctional energy storage system, the multi-function recombination unit may perform the multi-function recombination when an optimization result of the integrated objective function for the activation functions changes at a predetermined rate or greater per unit time.

In the multifunctional energy storage system, the multi-function recombination unit may automatically perform the multi-function recombination without a user's intervention during an operation of the multifunctional energy storage system.

In the multifunctional energy storage system, when the multi-function recombination unit performs the multi-function recombination, a function selected by a user may be essentially included in the optimal function combination.

In the multifunctional energy storage system, the multi-function controller may further include a reliability correction unit to generate a control value correction parameter on the basis of previous data about a difference between the control value and a measured value of each of the activation functions and to provide the control value correction parameter to the optimization controller, and the optimization controller may correct at least part of the control value of each of the activation functions on the basis of the control value correction parameter.

In the multifunctional energy storage system, the multi-function controller may further include a reliability correction unit to generate a constraint condition correction parameter on the basis of previous data about a difference between a predicted value and a measured value of input information and to provide the constraint condition correction parameter to the constraint condition generation unit, and the constraint condition generation unit may correct at least part of the constraint condition on the basis of the constraint condition correction parameter.

According to another aspect of the present disclosure, there is provided a multifunctional ESS operating system used for a multifunctional energy storage system that includes a battery and a power converter and is capable of selecting and simultaneously performing at least two activation functions among a plurality of functions, the multifunctional ESS operating system including: a multi-function controller to select the activation functions, to generate an integrated objective function, a weight, and a constraint condition corresponding to the activation functions, and to generate a control value for controlling each function included in the activation functions on the basis of the integrated objective function, the weight, and the constraint condition; and an individual function controller to receive the control value for each of the activation functions from the multi-function controller and to control the power converter so that each function is performed on the basis of the received control value.

In the multifunctional ESS operating system, the multi-function controller may include: a weight generation unit to generate the weight for each of the activation functions; an integrated objective function generation unit to generate the integrated objective function for all the activation functions by reflecting the weight; a constraint condition generation unit to generate the constraint condition for the activation functions; and an optimization controller to generate the control value for each of the activation functions on the basis of the integrated objective function and the constraint condition.

In the multifunctional ESS operating system, the multi-function controller may include a multi-function recombination unit to perform multi-function recombination of collecting future prediction information, generating a temporary function combination, providing the temporary function combination to the integrated objective function generation unit, the weight generation unit, and the constraint condition generation unit, receiving an optimization result of the temporary function combination from the optimization controller, selecting an optimal function combination on the basis of the optimization result of the temporary function combination, and providing the optimal function combination to a simultaneous control activation unit.

In the multifunctional ESS operating system, the simultaneous control activation unit may change the activation functions on the basis of the optimal function combination provided from the multi-function recombination unit.

In the multifunctional ESS operating system, when the multi-function recombination unit performs the multi-function recombination, a function selected by a user may be essentially included in the optimal function combination.

According to still another aspect of the present disclosure, there is provided an operating method for a multifunctional energy storage system performed by a multifunctional energy storage system that includes a battery and a power converter and is capable of selecting and simultaneously performing at least two activation functions among a plurality of functions, the method including: an operation of determining an activation function including a combination of a plurality of functions including a function selected by a user; an operation of generating a weight for each activation function and a constraint condition corresponding to the activation function; an operation of generating an integrated objective function corresponding to the entire activation function by reflecting the weight; an integrated objective function optimization operation of generating a control value for controlling each function included in the activation function on the basis of the integrated objective function and the constraint condition; and an operation of controlling the power converter so that each function of the activation function is performed on the basis of the control value.

In the operating method for the multifunctional energy storage system, the operating method may further include a multi-function recombination operation of changing the activation function by collecting future prediction information, generating a temporary function combination, calculating an optimization result of the temporary function combination, and selecting an optimal function combination on the basis of the optimization result of the temporary function combination.

In the operating method for the multifunctional energy storage system, in the multi-function recombination operation, the function selected by the user may be essentially included in the optimal function combination.

According to an embodiment of the present disclosure, it is possible to increase the utilization of an energy storage system by selectively performing various functions at the same time as necessary.

In addition, according to an embodiment of the present disclosure, it is possible to improve the profitability or performance of an energy storage system by automatically recombining and activating functions capable of optimizing an objective function among various functions depending on the situation.

Further, according to an embodiment of the present disclosure, a system may operate to reduce an error predicted when performing a function on the basis of previous data, thus increasing the reliability of a system.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 illustrates a multifunctional energy storage system according to an embodiment of the present disclosure;

FIG. 2 illustrates individual functions that a multifunctional energy storage system can perform according to an embodiment;

FIG. 3 illustrates a combination of functions that can be performed simultaneously among the individual functions illustrated in FIG. 2;

FIG. 4 illustrates a multi-function controller according to an embodiment;

FIG. 5 illustrates a multi-function controller including a multi-function recombination unit according to an embodiment;

FIG. 6 and FIG. 7 each illustrate a multi-function controller including a reliability correction unit according to an embodiment;

FIG. 8 to FIG. 10 each illustrate a multi-function controller including a multi-function recombination unit and a reliability correction unit according to an embodiment;

FIG. 11 illustrates a multi-function controller according to an embodiment; and

FIG. 12 and FIG. 13 each illustrate an operating method of a multifunctional energy storage system according to an embodiment.

### DETAILED DESCRIPTION OF THE EXEMPLARY EMBODIMENTS

Hereinafter, some exemplary embodiments of the present disclosure will be described in detail with reference to illustrative drawings. Throughout the drawings, wherever possible, the same reference numerals will be understood to refer to the same elements. When detailed descriptions about related known configurations or functions are determined to make the gist of the present disclosure unclear in describing the present disclosure, the detailed descriptions will be omitted herein.

In describing elements of the present disclosure, the terms “first”, “second”, “A”, “B”, “(a)”, “(b)”, and the like may be employed. These terms are used merely to distinguish an element from another an element and do not limit the nature, order, or sequence of an element. It will be understood that when an element is referred to as being “coupled to”, “combined with”, or “connected to” another element, the element can directly be coupled or connected to the other element, or a third element may be interposed therebetween.

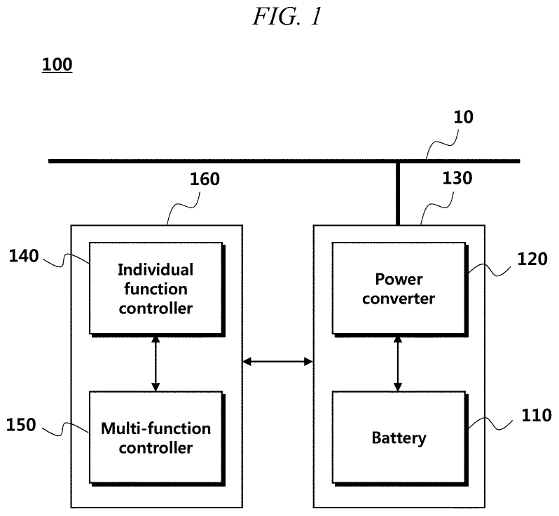

FIG. 1 illustrates a multifunctional energy storage system according to an embodiment of the present disclosure.

Referring to FIG. 1, the multifunctional energy storage system 100 may include an energy storage device 130 and a multifunctional ESS operating system 160. The energy storage device 130 may include a battery 110 and a power converter 120. The multifunctional ESS operating system 160 may include an individual function controller 140 and a multi-function controller 150.

The multifunctional energy storage system 100 may be understood as an energy storage system that is installed at a generating station, a transmission and distribution station, a distributed power source, or a consumer house and is capable of simultaneously performing various applications. The multifunctional energy storage system 100 generally operates in connection with a system 10 like a general energy storage system but is not necessarily connected to the system 10.

The battery 110 may be an electric energy storage device that can store excess power and can supply the power when needed. A lithium-ion type is generally used as the battery 110 of the energy storage system. However, the battery 110 is not limited thereto, but a nickel or lead battery or other types of batteries may be used.

The power converter 120 may be a device that converts and delivers power between the system 10 and the battery 110. When the system 10 is an alternating current, the power converter 120 may convert the alternating current of the system 10 into a direct current to supply the direct current to the battery 110, or may convert a direct current of the battery 110 into an alternating current to supply the alternating current to the system 10. When the system 10 is a direct current, the power converter 120 may perform a voltage conversion function according to a difference in level between the DC voltage of the system 10 and the DC voltage of the battery 110 and may bidirectionally deliver power between the system 10 and the battery 110. The power converter 120 may employ a general power conversion circuit using a semiconductor switching element.

The battery 110 and the power converter 120 may be understood to be included together in the energy storage device 130.

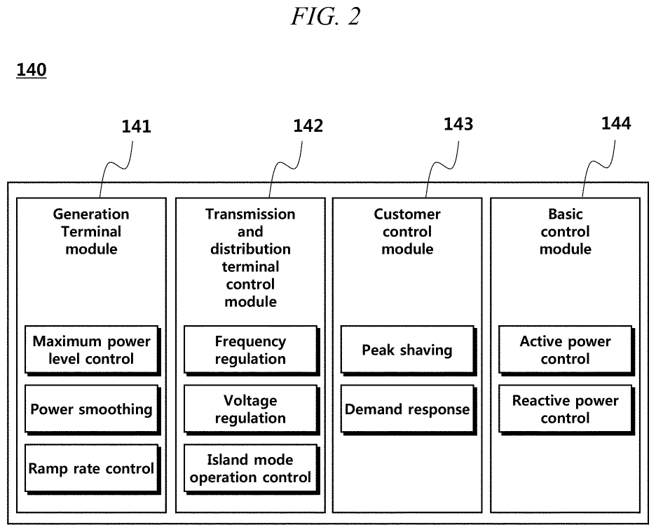

The individual function controller 140 may control the power converter 120 to perform each of a plurality of applications provided in the multifunctional energy storage system 100. To this end, as illustrated in FIG. 2, the individual function controller 140 may include a generating station control module 141, a transmission and distribution station control module 142, a customer control module 143, and a basic control module 144.

The generating station control module 141 may perform individual functions, for example, maximum power level control, ramp rate control, and power smoothing.

The transmission and distribution station control module 142 may perform individual functions, for example, frequency regulation, voltage regulation, and island mode operation control.

The customer control module 143 may perform individual functions, for example, peak shaving and demand response control.

The basic control module 144 may perform individual functions, for example, active power control and reactive power control.

Although FIG. 2 shows that the four control modules 141 to 144 perform ten individual functions, the types or number of individual functions and the number of control modules may be changed as necessary.

Referring back to FIG. 1, according to embodiments, the individual function controller 140 may receive a control value for each of activation functions (functions to be simultaneously performed at the current time point) from the multi-function controller 150 to be described below and may control the power converter 120 to perform each function on the basis of the received control value.

The multi-function controller 150 may select an activation function from among a plurality of individual functions included in the individual function controller 140 and may determine how to distribute and utilize the available charge/discharge capacity of the battery 110 for each activation function.

To this end, the multi-function controller 150 may select activation functions to be simultaneously performed at the current time point, may generate an integrated objective function, a weight and a constraint condition corresponding to the activation functions, and may generate a control value for controlling each function included in the activation functions on the basis of the integrated objective function, the weight, and the constraint condition. The generated control value may be transmitted to the individual function controller 140.

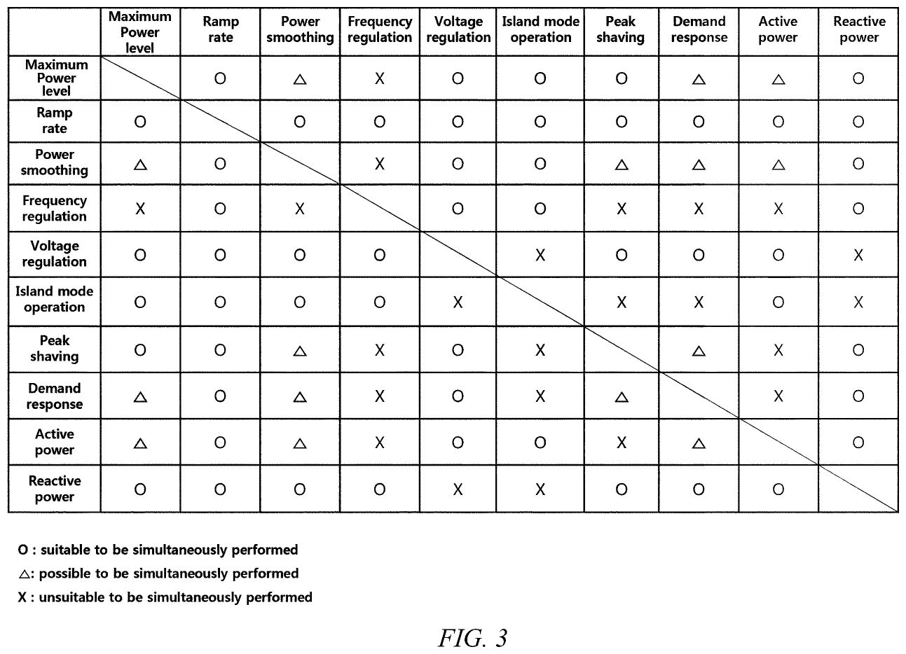

When selecting an activation function, the multi-function controller 150 needs to consider that at least some of the plurality of individual functions may be difficult to simultaneously perform. FIG. 3 illustrates a combination of individual functions that can be simultaneously performed. Referring to FIG. 3, for example, maximum power level control may be suitable to be simultaneously performed with ramp rate control, voltage regulation, island mode operation control, peak shaving, and reactive power control but may be unsuitable to be simultaneously performed with frequency regulation. Therefore, when selecting an activation function, the multi-function controller 150 may consider whether the individual functions are suitable to be simultaneously performed.

Further, when selecting an activation function, the multi-function controller 150 may select, as activation functions, at least some of functions that can be operated together with a function selected by a user. That is, when selecting an activation function, the multi-function controller 150 may essentially include a function selected by the user and may select an activation function from among functions suitable or possible to be simultaneously performed with the function selected by the user in view of other purposes (minimal cost and maximal profit).

The individual function controller 140 and the multi-function controller 150 may be configured as software programs to be stored in a computer-readable recording medium and to be executed by a conventional processor or the like. The individual function controller 140 and the multi-function controller 150 may be configured as one integrated entity or may be configured as separate entities. The individual function controller 140 and the multi-function controller 150 may be understood as forming the multifunctional ESS operating system 160 that operates the multifunctional energy storage system 100.

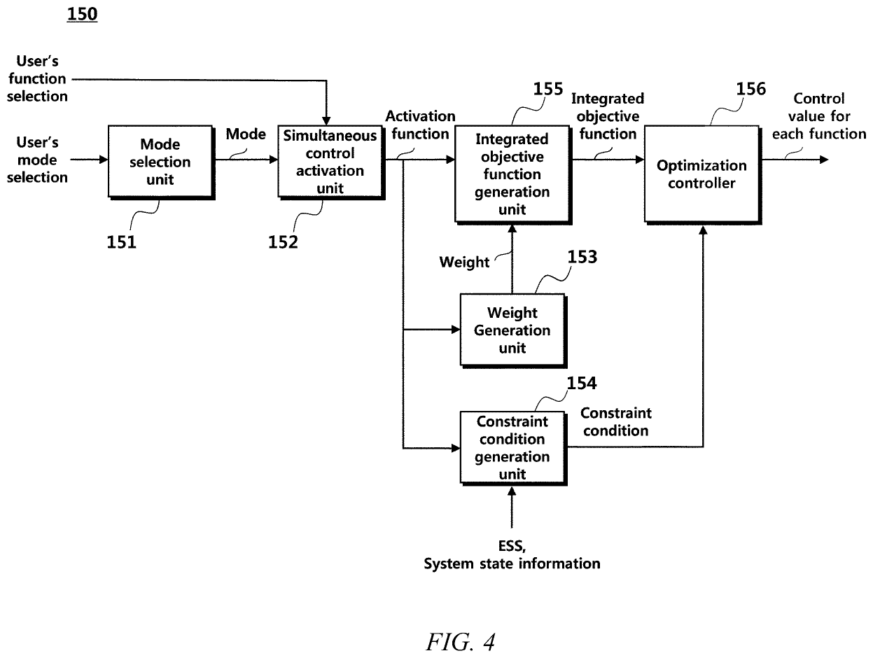

FIG. 4 illustrates a multi-function controller according to an embodiment.

Referring to FIG. 4, the multi-function controller 150 may include a mode selection unit 151, a simultaneous control activation unit 152, a weight generation unit 153, a constraint condition generation unit 154, an integrated objective function generation unit 155, and an optimization controller 156.

As described above, the multi-function controller 150 may select an activation function among a plurality of individual functions included in an individual function controller 140 and may determine how to distribute and utilize the available charge/discharge capacity of a battery 110 for each activation function.

The mode selection unit 151 may receive mode selection information from the user and may provide a mode selected by the user to the simultaneous control activation unit 152. To this end, the user may select a desired mode from among a plurality of predetermined modes and may provide corresponding information to the mode selection unit 151. The plurality of modes may include, for example, a system mode, a consumer mode, a regeneration mode, and an integration mode. For example, the system mode may be understood as a mode in which functions of frequency regulation, voltage regulation, and island mode operation control are mainly performed, and the customer mode may be understood as a mode in which functions of peak shaving and request response control are mainly performed. The regeneration mode may be understood as a mode in which functions of maximum power level control, ramp rate control, and power smoothing are mainly performed, and the integration mode may be understood as a mode in which any function of all the functions of the individual function controller 140 can be performed regardless of the system mode, the consumer mode, and the regeneration mode.

For example, each of the plurality of individual functions may be arranged not to belong to a plurality of modes, but one individual function may be arranged to belong to a plurality of modes. In another example of classifying modes, modes may be classified in terms of the user's purpose, such as a profit maximization mode, a cost minimization mode, a stability mode, and an emergency mode.

The simultaneous control activation unit 152 may receive information about the mode selected by the user from the mode selection unit 151 and may output an activation function. To this end, the simultaneous control activation unit 152 may present functions belonging to the mode selected by the user to the user, may allow the user to select a desired function, and may receive information about the function selected by the user.

In addition, the simultaneous control activation unit 152 may determine an activation function including at least some of functions that can be performed simultaneously with the function selected by the user. According to an embodiment, the simultaneous control activation unit 152 may include all the functions that can be performed simultaneously with the function selected by the user in the activation function. As described with reference to FIG. 3, a combination of functions that can be simultaneously performed may be determined in advance.

According to an embodiment, the simultaneous control activation unit 152 may selectively include functions having excellent optimization results when performed together with the function selected by the user in the activation function on the basis of past history data. In this case, the past data referenced by the simultaneous control activation unit 152 may be data about the result of simultaneously performing a plurality of functions in a similar environment (system state, weather condition, or the like) and at a similar operating time point (season, day, time, or the like).

The activation function output by the simultaneous control activation unit 152 may be provided to the weight generation unit 153, the constraint condition generation unit 154, and the integrated objective function generation unit 155.

The weight generation unit 153 may receive information about the activation function from the simultaneous control activation unit 152 and may generate a weight for each of the activation function. The weight generated by the weight generation unit 153 may be a weight for each function to be used when the integrated objective function generation unit 155 generates an integrated objective function of the activation function. Here, a weight for the same function may vary according to a combination of functions (activation function) to be simultaneously performed. For example, a weight for function A may be set to 0.3 when functions A, B, and C are simultaneously performed, and a weight for function A may be set to 0.2 when functions A, B, and D functions are simultaneously performed.

According to an embodiment, the weight generation unit 153 may generate a weight for each function using a weight table. To this end, the weight generation unit 153 may determine in advance an optimal weight combination for each combination of functions to be simultaneously performed by comparing the results of optimizing objective functions for various weight combinations on the basis of past history data (load, solar radiation quantity, wind speed, power generation amount of a distributed power source, or the like) and may store the optimal weight combination in a table for use.

According to an embodiment, the weight generation unit 153 may determine a weight for each function by applying reinforcement learning. It may be configured that a state for reinforcement learning is an objective function, an action is a weight for each function, and a reward is proportional to an increase/decrease in the result of the objective function.

According to an embodiment, the weight generation unit 153 may allow the user to adjust a weight according to the user's experience or situation.

The constraint condition generation unit 154 may receive the information about the activation function from the simultaneous control activation unit 152 and may generate a constraint condition for the activation function. The constraint condition generation unit 154 may collect information about the state of the energy storage device or the state of the system in order to generate the constraint condition. The constraint condition generated by the constraint condition generation unit 154 may be used when the optimization controller 156 optimizes the integrated objective function. For example, the constraint condition may be related to maximum active power or maximum reactive power for each function, the available power of the energy storage device, requirements of the system for system voltage or frequency change, or the like. For example, the constraint condition generation unit 154 may generate a constraint condition to be used for optimization of the integrated objective function on the basis of the state of the energy storage device or the state of the system.

The integrated objective function generation unit 155 may generate an integrated objective function for the entire activation function by reflecting the weight provided from the weight generation unit 153. To this end, for example, the integrated objective function generation unit 155 may generate an integrated objective function on the basis of an individual function objective function for each individual function and the weight provided from the weight generation unit 153. For example, the integrated objective function may be related to economic efficiency, such as cost minimization or profit maximization, or may be related to the quality or stability of the system.

For example, as shown in Equation 1 below, the integrated objective function generation unit 155 may generate an integrated objective function by adding the result of multiplying an objective function for each individual function included in the activation function by a weight for each individual function. In Equation 1, it is assumed that the activation function includes three individual functions.

A_{T}(t)=min{W₁(t)·A₁(P₁(t))+W(t)·A₂(P₂(t))W₃(t)·A₃(P₃(t))} [Equation 1]

Here, A_{T} is an integrated objective function, and W₁, W₂, and W₃ are a weight for a first function, a weight for a second function, and a weight for a third function, respectively. A₁, A₂, and A₃ are an objective function for the first function, an objective function for the second function, and an objective function for the third function, respectively, and P₁, P₂, and P₃ are power to be used by the first function, power to be used by the second function, and power to be used by the third function, respectively

Here, a constraint condition that can be used for optimization of the objective function of Equation 1 may include, for example, Equation 2 below.

P₁(t)+P₂(t)+P₃(t)≤P_{PCS,max} [Equation 2]

Here, P_{PCS, max} is the rated power of the power converter.

Equation 2 means a constraint condition such that the sum of the power (P₁) to be used by the first function, the power (P₂) to be used by the second function, and the power (P₃) to be used by the third function is less than or equal to the rated power (P_{PCS, max}) of the power converter.

According to an embodiment, an objective function corresponding to a different performance indicator may be used for each individual function. For example, a performance indicator corresponding to a system quality may be used as an objective function for a voltage regulation or frequency regulation function, and a performance indicator corresponding to cost minimization or profitability maximization may be used as an objective function for a demand response or peak shaving function. In this case, an integrated objective function needs to be unified to one performance indicator (one of system quality, cost, and profitability). When individual function objective functions for various performance indicators are integrated into one performance indicator, a weight may be set to perform adjustment between the performance indicators.

The optimization controller 156 may generate a control value for each activation function on the basis of the integrated objective function provided from the integrated objective function generation unit 155 and the constraint condition provided from the constraint condition generation unit 154. To this end, the optimization controller 156 may optimize the integrated objective function using the constraint condition. The control value for each activation function that the optimization controller 156 generates through optimization of the integrated objective function may selectively include, for example, active power, reactive power, a ramp rate value (e.g., %/sec compared to the maximum output) to be used by each function, or the like.

A control value for each function output by the optimization controller 156 may be transmitted to the individual function controller 140, as described with reference to FIG. 1, and may be used for the individual function controller 140 to control the power converter 120 so that each function is performed according to the control value.

As described above, the multifunctional energy storage system according to the embodiment of the present disclosure may selectively perform various functions at the same time as necessary, thereby increasing utilization of the energy storage system.

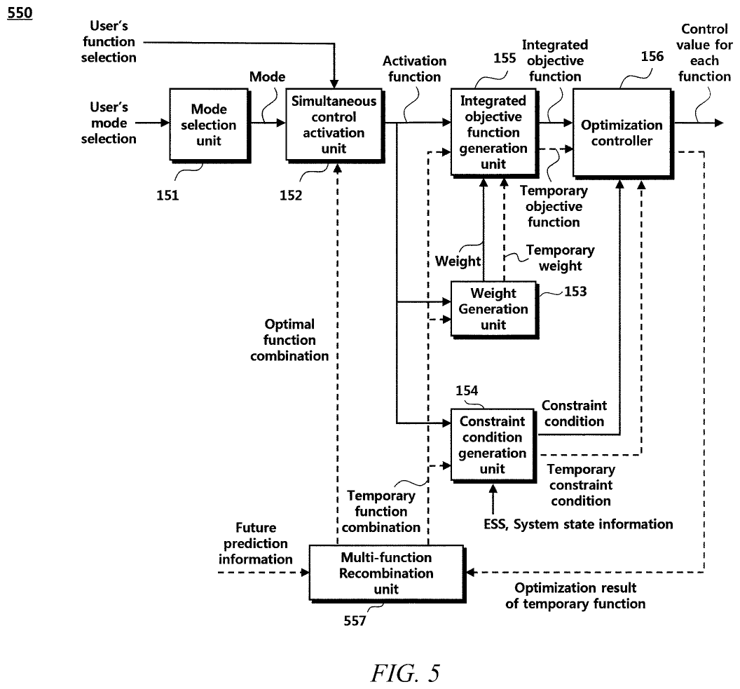

FIG. 5 illustrates a multi-function controller including a multi-function recombination unit according to an embodiment.

Referring to FIG. 5, the multi-function controller 550 is different from the multi-function controller 150 illustrated in FIG. 4 in that the multi-function controller 550 further includes the multi-function recombination unit 557. The details mentioned with reference to FIG. 4 may also be applied to the multi-function controller 550 of FIG. 5 unless contrary to the following description.

The multi-function recombination unit 557 may function to analyze whether there is a function combination (optimal function combination) having greater performance than an activation function currently performed on the basis of future prediction information. To this end, the multi-function recombination unit 557 may perform multi-function recombination of collecting future prediction information, generating a temporary function combination on the basis of the future prediction information, providing the temporary function combination to an integrated objective function generation unit 155, a weight generation unit 153, and a constraint condition generation unit 154, receiving the result of optimizing the temporary function combination from an optimization controller 156, selecting an optimal function combination on the basis of the result of optimizing the temporary function combination, and providing the optimal function combination to a simultaneous control activation unit 152.

In this process, the weight generation unit 153 may generate a temporary weight for the temporary function combination and may provide the temporary weight to the integrated objective function generation unit 155; the integrated objective function generation unit 155 may generate a temporary objective function for the temporary function combination and may provide the temporary objective function to the optimization controller 156; the constraint condition generation unit 154 may generate a temporary constraint condition for the temporary function combination and may provide the temporary constraint condition to the optimization controller 156; and the optimization controller 156 may generate the result of optimizing the temporary function combination on the basis of the temporary objective function received from the integrated objective function generation unit 155 and the temporary constraint condition received from the constraint condition generation unit 154 and may provide the result to the multi-function recombination unit 557. The simultaneous control activation unit 152 may change the activation function on the basis of the optimal function combination provided from the multi-function recombination unit 557.

The future prediction information collected by the multi-function recombination unit 557 may selectively include future system status, battery status, renewable power generation status, and information about weather. For example, the future prediction information may selectively include a power load prediction value, a renewable energy output prediction value, a battery state (SOC, SOH, SOL, or the like) prediction value, an electricity bill-related prediction value, a bid prediction value in a power demand management market, weather forecast information, or the like.

A method for the multi-function recombination unit 557 to generate the temporary function combination and to determine the optimal function combination may be implemented, for example, by extracting information about the result of optimizing a function combination in a situation similar to the future prediction information on the basis of previous data, selecting a plurality of function combinations having excellent optimization results, collecting and analyzing optimization results reflecting the future prediction information for a plurality of temporary function combinations, and determining an optimal function combination.

According to an embodiment, the multi-function recombination unit 557 may perform multi-function recombination when an inflection point occurs in the optimization result of the integrated objective function for the activation function. According to an embodiment, the multi-function recombination unit 557 may perform multi-function recombination when the optimization result of the integrated objective function for the activation function changes at a predetermined rate or greater per unit time. According to this embodiment, when the current activation function deviates from the optimal function combination and the performance thereof deteriorates due to a situational change, it is possible to quickly search for another optimal function combination.

According to an embodiment, the multi-function recombination unit 557 may automatically perform multi-function recombination without the user's intervention during the operation of the multifunctional energy storage system.

According to an embodiment, when the multi-function recombination unit 557 performs multi-function recombination, a function selected by the user may be essentially included in the optimal function combination.

As described above, according to the embodiment of FIG. 5, functions capable of optimizing the objective function according to the situation among various functions may be automatically recombined and activated, thereby improving profitability or performance of the energy storage system.

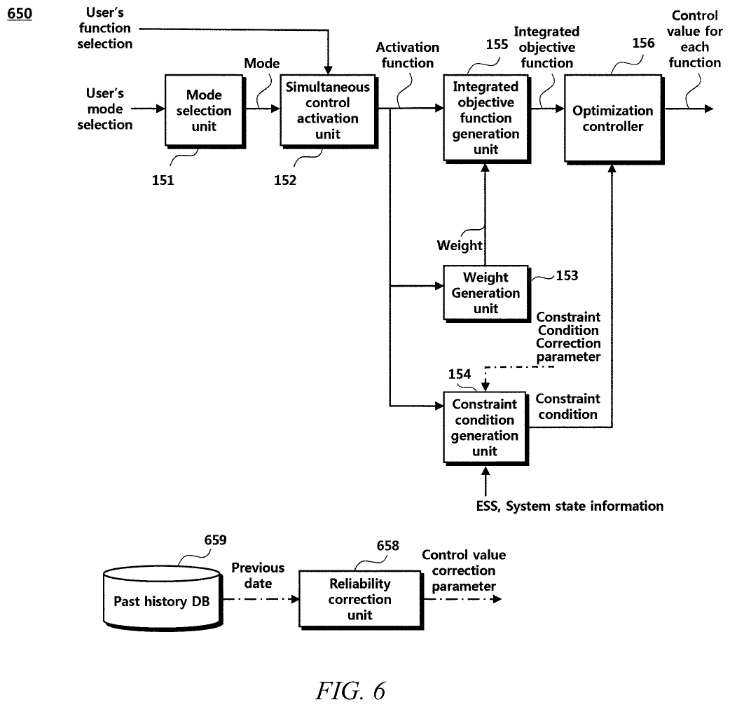

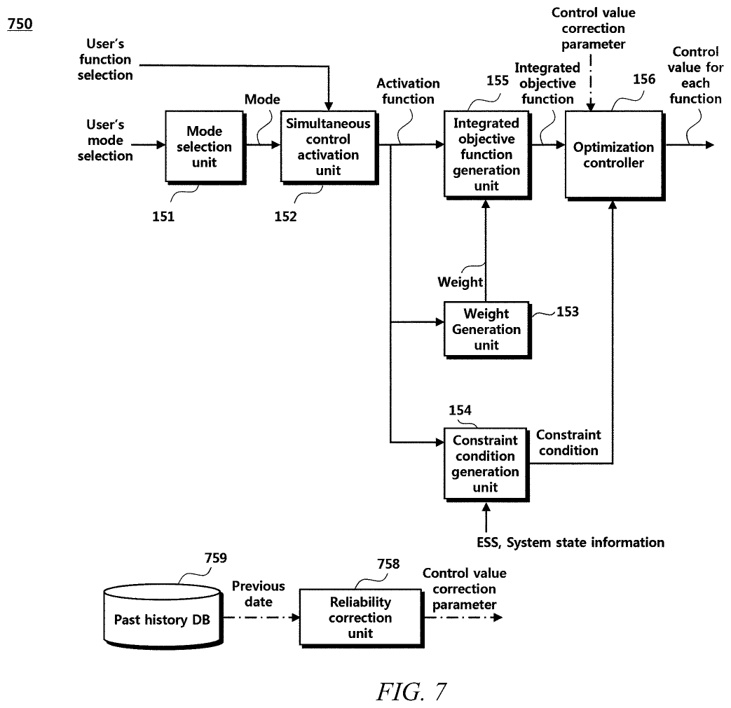

FIG. 6 and FIG. 7 each illustrate a multi-function controller including a reliability correction unit according to an embodiment.

Referring to FIG. 6, the multi-function controller 650 is different from the multi-function controller 150 illustrated in FIG. 4 in that the multi-function controller 650 further includes the reliability correction unit 658 and a past history database 659. The details mentioned with reference to FIG. 4 may also be applied to the multi-function controller 650 of FIG. 6 unless contrary to the following description.

The reliability correction unit 658 may generate a constraint condition correction parameter on the basis of previous data about the difference between a predicted value and a measured value of input information and may provide the constraint condition correction parameter to a constraint condition generation unit 154. In this case, the constraint condition generation unit 154 may correct at least part of a constraint condition on the basis of the constraint condition correction parameter provided from the reliability correction unit 658. Here, the input information may selectively include information about active power and reactive power for components included in the energy storage system, such as a power converter, a power load, and a renewable power source, information about a battery state (SOC, SOH, SOL, temperature, or the like), information about the voltage, frequency, and current of the system, and information about the past optimization result of an activation function.

For example, when the average error of a predicted value and a measured value of active power of the power load or renewable energy is ±10% on the basis of the past history data, Equation 2, which is a constraint condition for the maximum output of the power converter, may be changed as in Equation 3.

P₁(t)+P₂(t)+P₃(t)≤0.9·P_{PCS,max} [Equation 3]

That is, the constraint condition may be modified such that the sum of power P₁ to be used by the first function, power P₂ to be used by the second function, and power P₃ to be used by the third function is 90% or less of the rated power (P_{PCS, max}) of the power converter.

The past history database 659 may store a predicted value and a measured value of input information and information about an error thereof. For example, the past history database 659 may selectively store information including at least some of: a predicted value and a measurement value of active power and reactive power for components included in the energy storage system, such as a power converter, a power load, and a renewable power source and information about an error thereof; a predicted value and a measurement value with respect to a battery state (SOC, SOH, SOL, temperature, or the like) and information about an error thereof a predicted value and a measurement value of the voltage, frequency, and current of the system and information about an error thereof; and information about the past optimization result of an activation function.

Referring to FIG. 7, the multi-function controller 750 is different from the multi-function controller 150 illustrated in FIG. 4 in that the multi-function controller 750 further includes the reliability correction unit 758 and a past history database 759. The details mentioned with reference to FIG. 4 may also be applied to the multi-function controller 750 of FIG. 7 unless contrary to the following description.

The reliability correction unit 758 may generate a control value correction parameter on the basis of previous data about the difference between each control value and a measured value of an activation function and may provide the control value correction parameter to an optimization controller 156. In this case, the optimization controller 156 may correct at least part of each control value of the activation function on the basis of the control value correction parameter.

For example, the reliability correction unit 758 may analyze the difference between a control value and a measured value of each function statistically (using an average and a standard deviation) on the basis of past history data and may derive a confidence interval, thereby correcting a control value for each function output by the optimization controller 156. According to an embodiment, the corrected control value may be calculated by multiplying the control value for each function output by the optimization controller 156 by the control value correction parameter.

The past history database 759 may store each control value and a measured value of an activation function and information about an error thereof in addition to the content stored by the past history database 659 described with reference to FIG. 6.

As described above, according to the embodiments of FIG. 6 and FIG. 7, using a reliability correction unit makes it possible to prevent an unbalance, a fault, or an outage due to a prediction error in advance, thereby increasing reliability of the system.

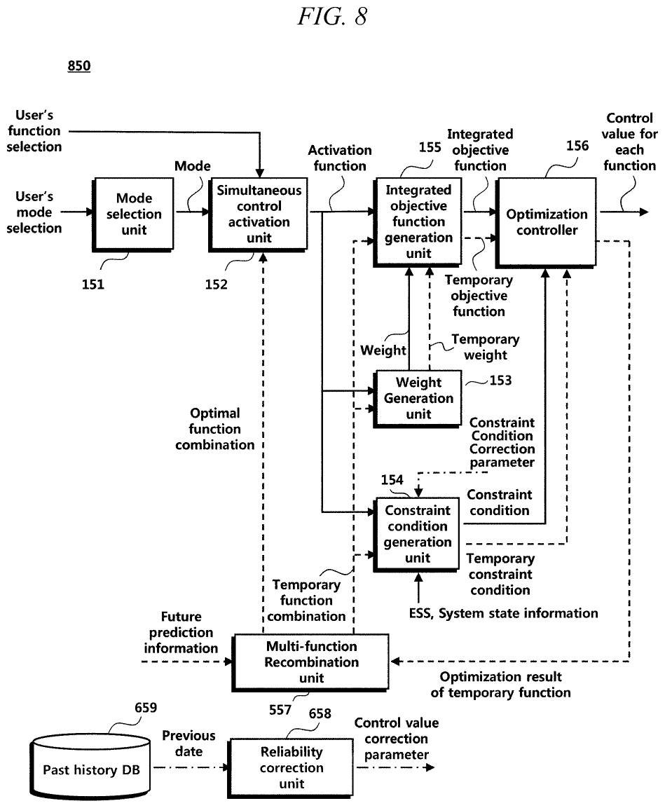

FIG. 8 to FIG. 10 each illustrate a multi-function controller including a multi-function recombination unit and a reliability correction unit according to an embodiment.

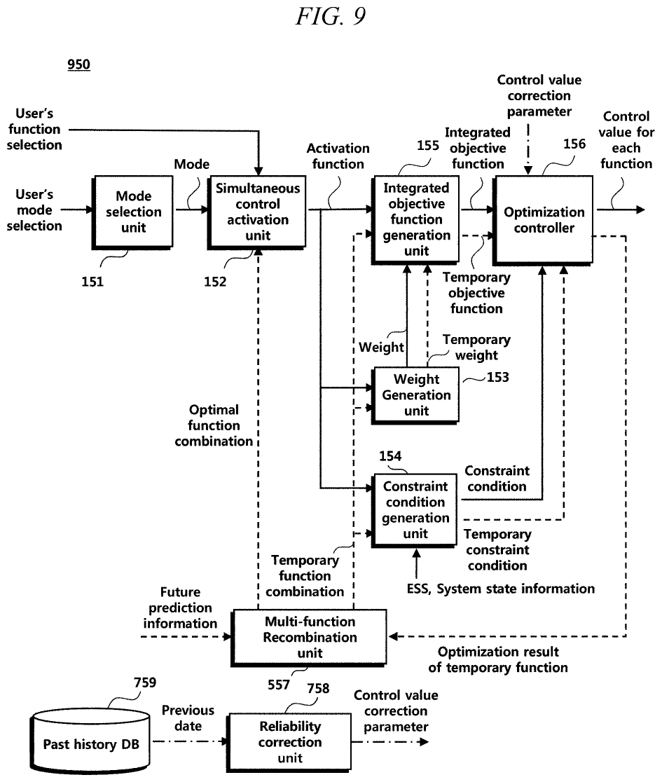

The multi-function controller 850 illustrated in FIG. 9 includes the multi-function recombination unit 557 illustrated in FIG. 5 and the reliability correction unit 658 and the past history database 659 illustrated in FIG. 6 together. The details mentioned with reference to FIG. 4, FIG. 5, and FIG. 6 may be applied to the operation of the multi-function controller 850 of FIG. 8.

The multi-function controller 950 illustrated in FIG. 8 includes the multi-function recombination unit 557 illustrated in FIG. 5 and the reliability correction unit 758 and the past history database 759 illustrated in FIG. 7 together. The details mentioned with reference to FIG. 4, FIG. 5, and FIG. 7 may be applied to the operation of the multi-function controller 950 of FIG. 9.

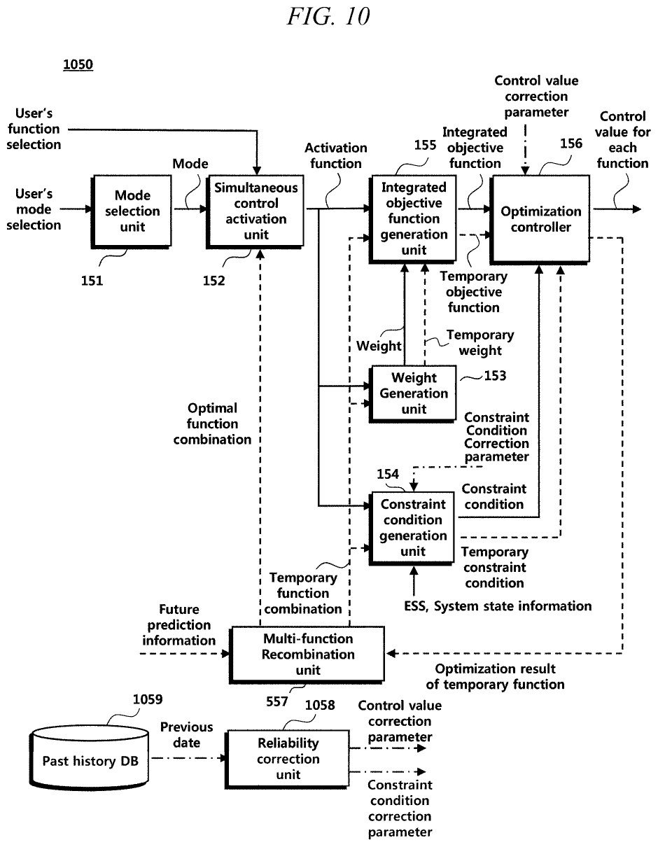

The multi-function controller 1050 illustrated in FIG. 10 includes the multi-function recombination unit 557 illustrated in FIG. 5 and a reliability correction unit 1058 having a combination of functions of the reliability correction unit 658 illustrated in FIG. 6 and the reliability correction unit 758 illustrated in FIG. 7, together. The details mentioned with reference to FIG. 4, FIG. 5, FIG. 6, and FIG. 7 may be applied to the operation of the multi-function controller 1050 of FIG. 10.

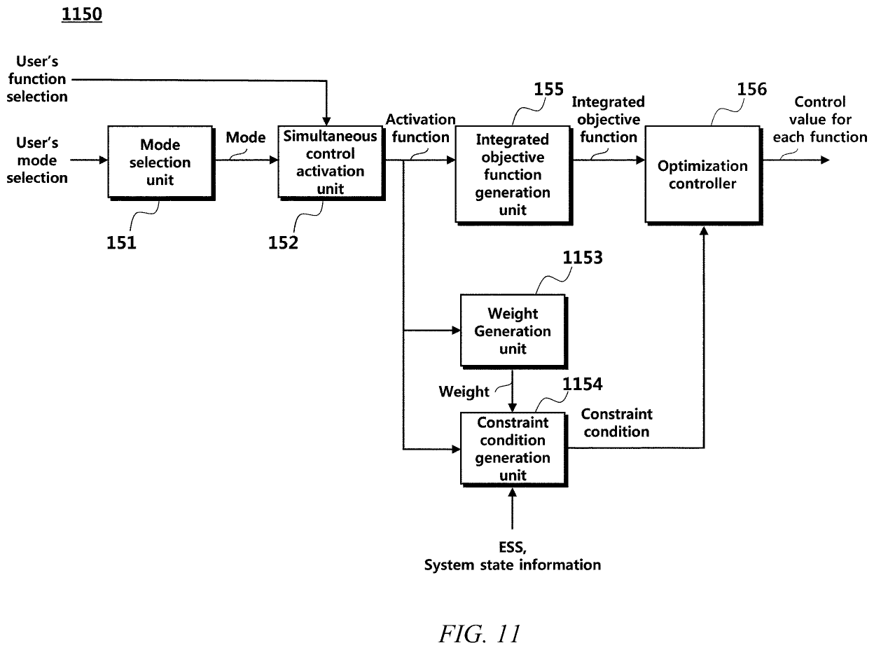

FIG. 11 illustrates a multi-function controller according to an embodiment.

The multi-function controller 1150 illustrated in FIG. 11 is different from the multi-function controller 150 illustrated in FIG. 4 in that a weight generated by a weight generation unit 1153 is provided to a constraint condition generation unit 1154 and the constraint condition generation unit 1154 generates a constraint condition by reflecting the weight received from the weight generation unit 1153. The details mentioned with reference to FIG. 4 may also be applied to the multi-function controller 1150 of FIG. 11 unless contrary to the following description.

In the multi-function controller 1150 illustrated in FIG. 11, since the weight is reflected in the constraint condition rather than an integrated objective function, the integrated objective function (A_{T}) may not reflect the weight (W₁, W₂, and W₃) as shown in Equation 4 below, and the constraint condition may reflect the weight (W₁, W₂, and W₃) instead as shown in Equation 5 below.

A_{T}M=min{A₁(P₁(t))+A₂(P₂(t))+A₃(P₃(t))} [Equation 4]

P₁(t)≤W₁(t)·P_{PCS,max}

P₂(t)≤W₂(t)·P_{PCS,max}

P₃(t)≤W₃(t)·P_{PCS,max} [Equation 5]

Equation 5 illustrates a method for calculating the upper limit (part of the constraint condition) of power (P₁, P₂, and P₃) to be used by each individual function by multiplying the rated power (P_{PCS, max}) of the power converter and the weight (W₁, W₂, and W₃) for each function. Equation 5 is only an example of a method for generating a constraint condition that reflects a weight, and there may be various methods for reflecting a weight in a constraint condition.

According to an embodiment, a weight may be reflected in an objective function as shown in FIG. 4 and may also be reflected in a constraint condition as shown in FIG. 11. In this case, a weight for an objective function may be used separately from a weight for a constraint condition. Also, according to an embodiment, a plurality of weights to be reflected in a constraint condition rather than one weight may be used so that the weights may be reflected in various constraint conditions.

The embodiments including the multi-function recombination unit and/or the reliability correction unit illustrated in FIG. 5 to FIG. 10 may also be applied to the multi-function controller 1150 of FIG. 11.

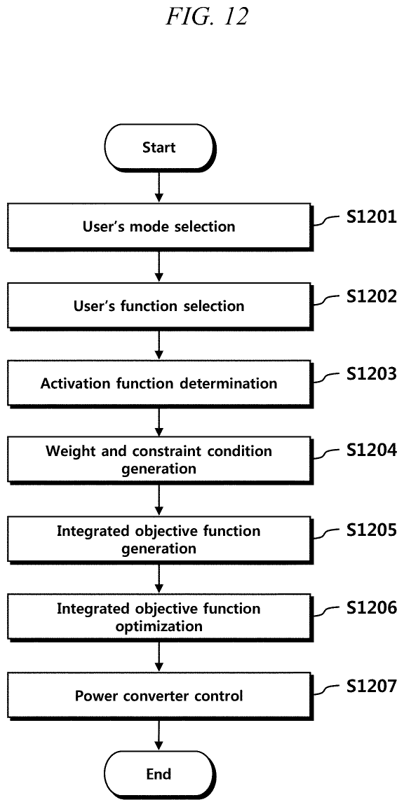

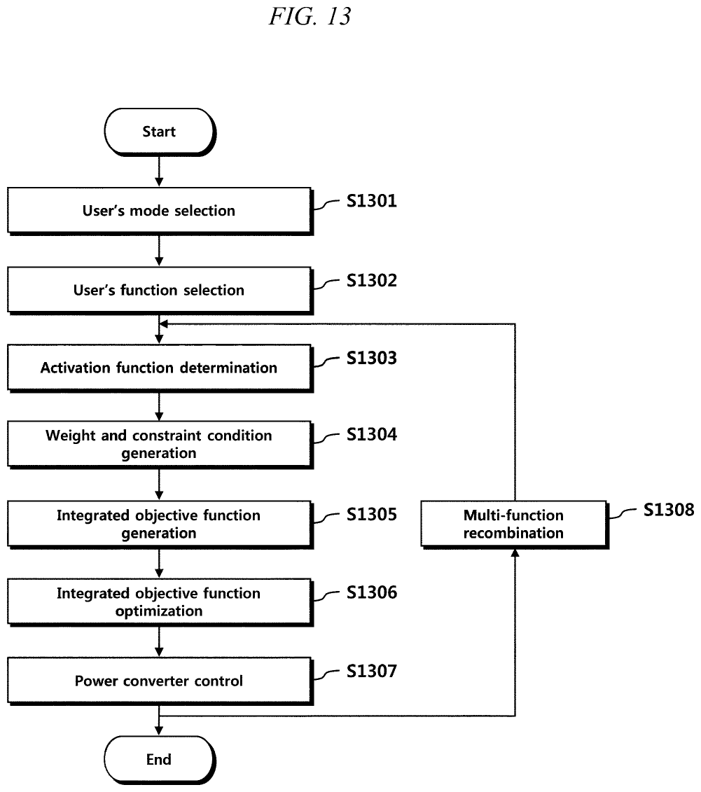

FIG. 12 and FIG. 13 each illustrate an operating method of a multifunctional energy storage system according to an embodiment. The operating methods of FIG. 12 and FIG. 13 may be performed by the multifunctional energy storage system described with reference to FIG. 1 to FIG. 11.

Referring to FIG. 12, the operating method of the multifunctional energy storage system may include: a user mode selection operation (S1201) of receiving mode selection information from a user; a user function selection operation (S1202) of receiving function selection information from the user among functions corresponding to a selected mode; an operation (S1203) of determining an activation function including a combination of a plurality of functions including a function selected by the user; an operation (S1204) of generating a weight for each activation function and a constraint condition corresponding to the activation function; an operation (S1205) of generating an integrated objective function corresponding to the entire activation function by reflecting the weight; an integrated objective function optimization operation (S1206) of generating a control value for controlling each function included in the activation function on the basis of the integrated objective function and the constraint condition; and an operation (S1207) of controlling a power converter so that each function of the activation function is performed on the basis of the control value generated by integrated objective function optimization.

Referring to FIG. 13, the operating method of the multifunctional energy storage system is different from the operating method illustrated in FIG. 12 in that the operating method further includes a multi-function recombination operation (S1308).

In the multi-function recombination operation (S1308), future prediction information may be collected, a temporary function combination may be generated, the result of optimizing the temporary function combination may be obtained, and an optimal function combination may be selected on the basis of the result of optimizing the temporary function combination, thereby changing the activation function.

Details mentioned with reference to FIG. 1 to FIG. 11 may be applied to specific operations of each operation illustrated in FIG. 12 and FIG. 13.

As described above, according to an embodiment of the present disclosure, it is possible to increase the utilization of an energy storage system by selectively performing various functions at the same time as necessary. In addition, according to an embodiment of the present disclosure, it is possible to improve the profitability or performance of an energy storage system by automatically recombining and activating functions capable of optimizing an objective function among various functions depending on the situation. Further, according to an embodiment of the present disclosure, a system may operate to reduce an error predicted when performing a function on the basis of previous data, thus increasing the reliability of a system.

Unless specified otherwise, the term “include”, “configure”, or “have” used herein refers to the existence of a component and thus should be construed as further including other components rather than excluding other components. Unless defined otherwise, all terms including technical and scientific terms used herein have the same meaning as commonly understood by those having ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The foregoing description is provided merely to describe the technical idea of the present disclosure, and it will be apparent to those having ordinary skill in the art to which this disclosure belongs that various modifications and variations can be made in the present disclosure without departing from the essential characteristics of the present disclosure. The embodiments disclosed herein are provided not to limit but to describe the technical idea of the present disclosure and do not limit the scope of the present disclosure. The scope of the present disclosure should be construed as being defined by the appended claims, and any technical ideas within the appended claims and their equivalents should be construed as being included in the scope of the present disclosure.

What is claimed is:

1. A multifunctional energy storage system capable of selecting and simultaneously performing at least two activation functions among a plurality of functions, the multifunctional energy storage system comprising:
a battery;
a power converter to transfer power between a system and the battery;
a multi-function controller to select the activation functions, to generate an integrated objective function, a weight, and a constraint condition corresponding to the activation functions, and to generate a control value for controlling each function comprised in the activation functions on the basis of the integrated objective function, the weight, and the constraint condition; and
an individual function controller to receive the control value for each of the activation functions from the multi-function controller and to control the power converter so that each function is performed on the basis of the received control value.

2. The multifunctional energy storage system of claim 1, wherein the plurality of functions comprise at least two among maximum power level control, ramp rate control, power smoothing, frequency regulation, voltage regulation, island mode operation control, peak shaving, demand response control, active power control, and reactive power control.

3. The multifunctional energy storage system of claim 1, wherein the multi-function controller selects, as the activation functions, at least some of functions operable together with a function selected by a user.

4. The multifunctional energy storage system of claim 1, wherein the multi-function controller comprises:
a weight generation unit to generate the weight for each of the activation functions;
an integrated objective function generation unit to generate the integrated objective function for all the activation functions by reflecting the weight;
a constraint condition generation unit to generate the constraint condition for the activation functions; and
an optimization controller to generate the control value for each of the activation functions on the basis of the integrated objective function and the constraint condition.

5. The multifunctional energy storage system of claim 4, wherein the multi-function controller comprises a multi-function recombination unit to perform multi-function recombination of collecting future prediction information, generating a temporary function combination, providing the temporary function combination to the integrated objective function generation unit, the weight generation unit, and the constraint condition generation unit, receiving an optimization result of the temporary function combination from the optimization controller, selecting an optimal function combination on the basis of the optimization result of the temporary function combination, and providing the optimal function combination to a simultaneous control activation unit.

6. The multifunctional energy storage system of claim 5, wherein the simultaneous control activation unit changes the activation functions on the basis of the optimal function combination provided from the multi-function recombination unit.

7. The multifunctional energy storage system of claim 5, wherein the multi-function recombination unit performs the multi-function recombination when an inflection point occurs in an optimization result of the integrated objective function for the activation functions.

8. The multifunctional energy storage system of claim 5, wherein the multi-function recombination unit performs the multi-function recombination when an optimization result of the integrated objective function for the activation functions changes at a predetermined or greater rate per unit time.

9. The multifunctional energy storage system of claim 5, wherein the multi-function recombination unit automatically performs the multi-function recombination without a user's intervention during an operation of the multifunctional energy storage system.

10. The multifunctional energy storage system of claim 5, wherein, when the multi-function recombination unit performs the multi-function recombination, a function selected by a user is comprised in the optimal function combination.

11. The multifunctional energy storage system of claim 4, wherein the multi-function controller further comprises a reliability correction unit to generate a control value correction parameter on the basis of previous data about a difference between the control value and a measured value of each of the activation functions and to provide the control value correction parameter to the optimization controller, and the optimization controller corrects at least a part of the control value of each of the activation functions on the basis of the control value correction parameter.

12. The multifunctional energy storage system of claim 4, wherein the multi-function controller further comprises a reliability correction unit to generate a constraint condition correction parameter on the basis of previous data about a difference between a predicted value and a measured value of input information and to provide the constraint condition correction parameter to the constraint condition generation unit, and the constraint condition generation unit corrects at least part of the constraint condition on the basis of the constraint condition correction parameter.

13. A multifunctional ESS (energy storage system) operating system used for a multifunctional energy storage system that comprises a battery and a power converter and is capable of selecting and simultaneously performing at least two activation functions among a plurality of functions, the multifunctional ESS operating system comprising:
a multi-function controller to select the activation functions, to generate an integrated objective function, a weight, and a constraint condition corresponding to the activation functions, and to generate a control value for controlling each function comprised in the activation functions on the basis of the integrated objective function, the weight, and the constraint condition; and
an individual function controller to receive the control value for each of the activation functions from the multi-function controller and to control the power converter so that each function is performed on the basis of the received control value.

14. The multifunctional ESS operating system of claim 13, wherein the multi-function controller comprises:
a weight generation unit to generate the weight for each of the activation functions;
an integrated objective function generation unit to generate the integrated objective function for all the activation functions by reflecting the weight;
a constraint condition generation unit to generate the constraint condition for the activation functions; and
an optimization controller to generate the control value for each of the activation functions on the basis of the integrated objective function and the constraint condition.

15. The multifunctional ESS operating system of claim 14, wherein the multi-function controller comprises a multi-function recombination unit to perform multi-function recombination of collecting future prediction information, generating a temporary function combination, providing the temporary function combination to the integrated objective function generation unit, the weight generation unit, and the constraint condition generation unit, receiving an optimization result of the temporary function combination from the optimization controller, selecting an optimal function combination on the basis of the optimization result of the temporary function combination, and providing the optimal function combination to a simultaneous control activation unit.

16. The multifunctional ESS operating system of claim 15, wherein the simultaneous control activation unit changes the activation functions on the basis of the optimal function combination provided from the multi-function recombination unit.

17. The multifunctional ESS operating system of claim 15, wherein, when the multi-function recombination unit performs the multi-function recombination, a function selected by a user is comprised in the optimal function combination.

18. An operating method for a multifunctional energy storage system performed by a multifunctional energy storage system that comprises a battery and a power converter and is capable of selecting and simultaneously performing at least two activation functions among a plurality of functions, the method comprising steps of:
determining an activation function in which a plurality of functions, including a function selected by a user, are combined;
generating a weight for each activation function and a constraint condition corresponding to the activation function;
generating an integrated objective function corresponding to the entire activation function by reflecting the weight;
optimizing an integrated objective function by generating a control value for controlling each function comprised in the activation function on the basis of the integrated objective function and the constraint condition; and
controlling the power converter so that each function of the activation function is performed on the basis of the control value.

19. The operating method of claim 18, further comprising a multi-function recombination step of changing the activation function by collecting future prediction information, generating a temporary function combination, calculating an optimization result of the temporary function combination, and selecting an optimal function combination on the basis of the optimization result of the temporary function combination to change the activation function.

20. The operating method of claim 19, wherein, in the multi-function recombination step, a function selected by the user is comprised in the optimal function combination.
